(19) United States
(12) Patent Application Publication
(10) Pub. No.: US 2006/0049759 A1
(43) Pub. Date: Mar. 9, 2006

(54) Plasma display apparatus and manufacturing method thereof

(76) Inventor: Woong Kee Min, Seoul (KR)

Correspondence Address: MCKENNA LONG & ALDRIDGE LLP;Song K. Jung, 1900 K Street, N.W., Washington, DC, 20006, US

(21) Appl. No.: 11/218,557

(22) Filed: Sep. 6, 2005

(30) Foreign Application Priority Data
Sep. 7, 2004 (KR) 10-2004-0071477

(51) Int. Cl. H01J 17/49

(52) U.S. Cl. 313/583

(57) ABSTRACT

The present invention provides a plasma display apparatus in which the area occupied by driving boards can be reduced and the manufacturing cost due to the driving boards can be reduced. The plasma display panel of the present invention includes a glass substrate in which scan electrodes and sustain electrodes are formed, a first electrode connection unit formed on one side of the glass substrate, for transmitting a first driving pulse to the scan electrodes, a signal transmission unit formed in the glass substrate and electrically connected to the sustain electrodes that are commonly connected to the other side of the glass substrate, and a second electrode connection unit formed on one side of the glass substrate, for transmitting a second driving pulse to the signal transmission unit. The preset invention can lower the manufacturing cost that is increased due to driving units and reduce the area occupied by driving units through a signal transmission unit formed on an ineffective surface of a glass substrate so as to be connected to sustain electrodes and an electrode connection unit formed on one side of the glass substrate.

### CROSS-REFERENCES TO RELATED APPLICATIONS

This Nonprovisional application claims priority under 35 U.S.C. § 119(a) on Patent Application No. 10-2004-0071477 filed in Korea on Sep. 07, 2004 the entire contents of which are hereby incorporated by reference.

### BACKGROUND OF THE INVENTION

1. Field of the Invention

The present invention relates to a plasma display apparatus and manufacturing method thereof, and more particularly, to a plasma display apparatus including electrodes and manufacturing method thereof.

2. Background of the Related Art

In general, a plasma display apparatus includes an upper substrate and a lower substrate. Gaps between the upper substrate and the lower substrate are sustained by barrier ribs. The barrier ribs form a unit cell. Each cell is filled with a main discharge gas such as neon (Ne) or helium (He), and an inert gas containing a small amount of xenon.

If a high frequency voltage is applied, the inert gas generates vacuum (UV) rays and emits phosphors, thus displaying images. The panel of this plasma display apparatus is thin and light, and has thus been in the spotlight as next-generation display devices.

FIG. 1 shows the panel structure of a common plasma display apparatus. As shown in FIG. 1, the panel of the common plasma display apparatus includes an upper substrate 100 on which images are displayed and a lower substrate 110.

A scan electrode 101 and a sustain electrode 102 are formed in the upper substrate 100. Each of the scan electrode 101 and the sustain electrode 102 includes a transparent electrode “a” made of a transparent ITO material, and a bus electrode “b” made of a metal material. A dielectric layer 103 covers the scan electrode 101 and the sustain electrode 102, limits the discharge current and provides insulation among the electrodes. A protection layer 104 is formed on a top surface of the dielectric layer 103 by deposition of magnesium oxide (MgO), and it serves to protect the electrodes and emit secondary electrons.

Barrier ribs 111 for forming discharge cells are formed in the lower substrate 110. A number of address electrodes 112 is also disposed parallel to the barrier ribs 111. R, G and B phosphors 113 that emit a visible ray are coated between the barrier ribs 111. A white dielectric layer 114 protects the address electrodes 112 and reflects a visible ray, which is radiated from the phosphors 113, to the upper substrate 100.

FIG. 2 shows a conventional plasma display apparatus. As shown in FIG. 2, a plasma display panel 20 includes address electrodes X1 to Xm, scan electrodes Y1 to Yn and sustain electrodes Z1 to Zn.

The address electrodes are arranged from X1 to Xn in a perpendicular direction. The scan electrodes are arranged from Y1 to Yn in a lateral direction on one side of the plasma display panel 20. The sustain electrode are sequentially arranged from Z1 to Zn on an opposite side to the one side.

A first electrode pad 35 transmits a ramp pulse for initializing the charge state within a cell, a scan pulse for an address discharge and a sustain pulse for sustaining the discharge to the scan electrodes Y1 to Yn. A second electrode pad 55 transmits a sustain pulse, which is alternated with the sustain pulse applied to the scan electrodes Y1 to Yn, to the sustain electrodes Z1 to Zn. The first electrode pad 35 and the second electrode pad 55 are formed at both sides of the plasma display panel.

The scan driving unit 30 applies the ramp pulse, the scan pulse and the sustain pulse to the scan electrodes Y1 to Yn through the first electrode pad 35.

The data driving unit 40 applies an address pulse to the address electrodes X1 to Xm in synchronization with the scan pulse applied by the scan driving unit 30.

A sustain driving unit 50 applies a sustain pulse, which is alternated with the sustain pulse applied by the scan driving unit 30, to the sustain electrodes Z1 to Zn through the second electrode pad 55.

At this time, by way of the structure of this common plasma display apparatus, the application direction of the driving pulse applied to the scan electrodes Y1 to Yn and the application direction of the driving pulse applied to the sustain electrodes Z1 to Zn are opposite to each other since the first electrode pad 35 and the second electrode pad 55 are formed at both sides of the plasma display panel.

Accordingly, the driving board in which the scan driving unit 30 and the sustain driving unit 50 are implemented is formed at both sides of a frame attached to a rear surface of the plasma display panel.

FIG. 3 shows an exemplary arrangement of each driving board attached on the frame of the conventional plasma display apparatus. As shown in FIG. 3, a scan driving board 60, a data driving board 70 and a sustain driving board 80 are attached on a frame 90. The frame 90 supports the plasma display panel 20 and radiates heat generated from the plasma display panel 20 to the outside.

The scan driving board 60 is attached to one side of the frame 90 and is electrically connected to the scan electrodes formed on one side of the plasma display panel 20. The sustain driving board 80 is attached to the other side of the frame 90, which is opposite to the one side, and is electrically connected to the sustain electrodes formed on the other side of the plasma display panel 20.

This conventional plasma display apparatus must have two driving boards since the first electrode pad 35 and the second electrode pad 55 are respectively formed at both sides of the plasma display panel. Accordingly, there are problems in that the manufacturing cost rises and the area occupied by the driving boards is increased.

### SUMMARY OF THE INVENTION

Accordingly, the present invention has been made in view of the above problems, and it is an object of the present invention to provide a plasma display apparatus in which the area occupied by driving boards can be reduced and the manufacturing cost due to the driving boards can be reduced.

To achieve the above object, a plasma display panel according to the present invention includes a glass substrate in which scan electrodes and sustain electrodes are formed, a first electrode connection unit formed on one side of the glass substrate, for transmitting a first driving pulse to the scan electrodes, a signal transmission unit formed in the glass substrate and electrically connected to the sustain electrodes that are commonly connected to the other side of the glass substrate, and a second electrode connection unit formed on one side of the glass substrate, for transmitting a second driving pulse to the signal transmission unit.

The first electrode connection unit and the second electrode connection unit may be electrode pads.

The scan electrodes, the sustain electrodes and the signal transmission unit may be formed of the same material.

The signal transmission unit may be formed on an ineffective surface of the glass substrate.

The signal transmission unit may be formed on an ineffective surface on the glass substrate.

The signal transmission unit may be formed on an ineffective surface below the glass substrate.

The signal transmission unit may be formed on ineffective surfaces on and below the glass substrate.

The signal transmission unit may include a first part signal transmission unit and a second part signal transmission unit. The first part signal transmission unit may be electrically connected to a part of the sustain electrodes formed on the other side of the glass substrate and is formed on an ineffective surface on the glass substrate. Further, the second part signal transmission unit may be electrically connected to the remaining sustain electrodes formed on the other side of the glass substrate and is formed on an ineffective surface below the glass substrate.

The signal transmission unit may commonly connect the sustain electrodes formed on the other side of the glass substrate.

A plasma display apparatus according to the present invention includes an integrated driving unit for generating a first driving pulse and a second driving pulse, a glass substrate in which scan electrodes and sustain electrodes are formed; a first electrode connection unit formed on one side of the glass substrate, for transmitting a first driving pulse to the scan electrodes, a signal transmission unit formed in the glass substrate and electrically connected to the sustain electrodes that are commonly connected to the other side of the glass substrate, and a second electrode connection unit formed on one side of the glass substrate, for transmitting a second driving pulse to the signal transmission unit.

The scan electrodes, the sustain electrodes and the signal transmission unit may be formed of the same material.

The signal transmission unit may be formed on an ineffective surface of the glass substrate.

The signal transmission unit may be formed on an ineffective surface on the glass substrate.

The signal transmission unit may be formed on an ineffective surface below the glass substrate.

The signal transmission unit may be formed on ineffective surfaces on and below the glass substrate.

The signal transmission unit may include a first part signal transmission unit and a second part signal transmission unit. The first part signal transmission unit may be electrically connected to a part of the sustain electrodes formed on the other side of the glass substrate and is formed on an ineffective surface on the glass substrate. Further, the second part signal transmission unit may be electrically connected to the remaining sustain electrodes formed on the other side of the glass substrate and is formed on an ineffective surface below the glass substrate.

The signal transmission unit may commonly connect the sustain electrodes formed on the other side of the glass substrate.

A method of manufacturing a plasma display panel having scan electrodes and sustain electrodes according to the present invention includes the steps of forming a signal transmission unit on a glass substrate using the same electrode material, the signal transmission unit being connected to the scan electrodes and the sustain electrodes and being located on an ineffective surface of the glass substrate, forming a first electrode connection unit connected to the scan electrodes on one side of the glass substrate, and forming a second electrode connection unit connected to the signal transmission unit on one side of the glass substrate.

The scan electrodes, the sustain electrodes and the signal transmission unit may be formed on the same plane of the glass substrate.

The formation of the scan electrodes, the sustain electrodes and the signal transmission unit may be performed by a photolithography method or a screen printing method.

### BRIEF DESCRIPTION OF THE DRAWINGS

Further objects and advantages of the invention can be more fully understood from the following detailed description taken in conjunction with the accompanying drawings in which:

FIG. 1 shows the panel structure of a general plasma display apparatus;

FIG. 2 shows a conventional plasma display apparatus;

FIG. 3 shows an exemplary arrangement of each driving board attached on a frame of the conventional plasma display apparatus;

FIG. 4 shows a first embodiment of a plasma display panel according to the present invention;

FIG. 5 shows a first embodiment of a plasma display apparatus including the plasma display panel of FIG. 4 according to the present invention;

FIG. 6 shows a second embodiment of a plasma display panel according to the present invention;

FIG. 7 shows a second embodiment of a plasma display apparatus including the plasma display panel of FIG. 6 according to the present invention;

FIG. 8 shows a third embodiment of a plasma display panel according to the present invention;

FIG. 9 shows a third embodiment of a plasma display apparatus including the plasma display panel of FIG. 8 according to the present invention;

FIG. 10 shows a fourth embodiment of a plasma display panel according to the present invention;

FIG. 11 shows a fourth embodiment of a plasma display apparatus including the plasma display panel of FIG. 10 according to the present invention; and

FIGS. 12a to 12e show a process of manufacturing a plasma display panel according to the present invention.

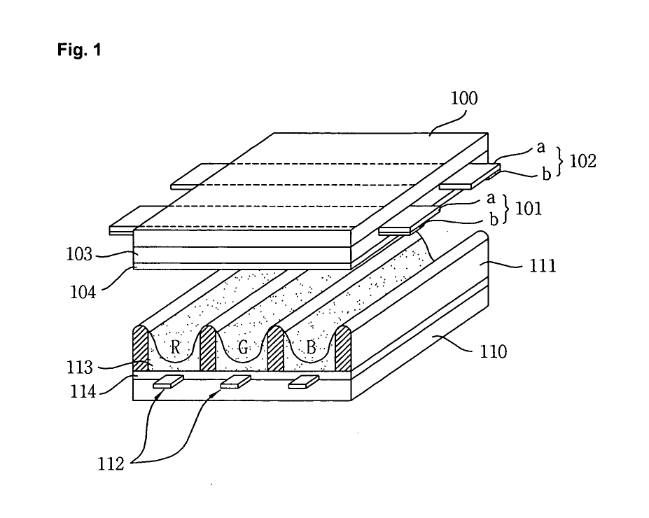

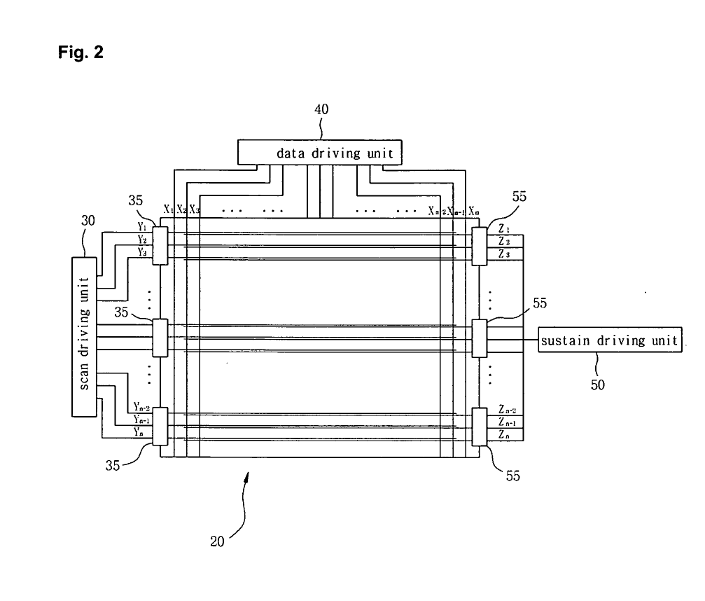

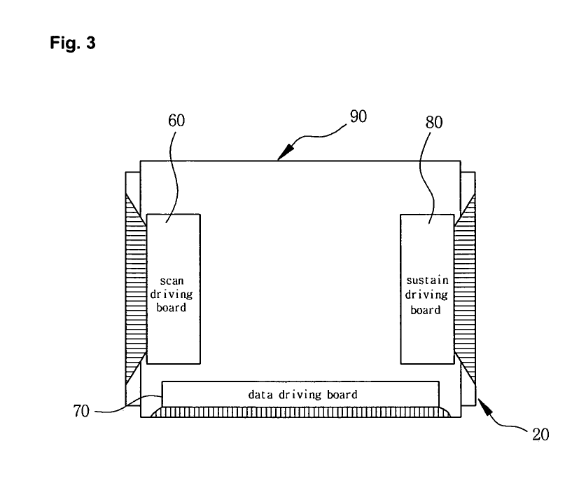

### DETAILED DESCRIPTION OF THE PREFERRED EMBODIMENT

The present invention will now be described in detail in connection with preferred embodiments with reference to the accompanying drawings.

### First Embodiment

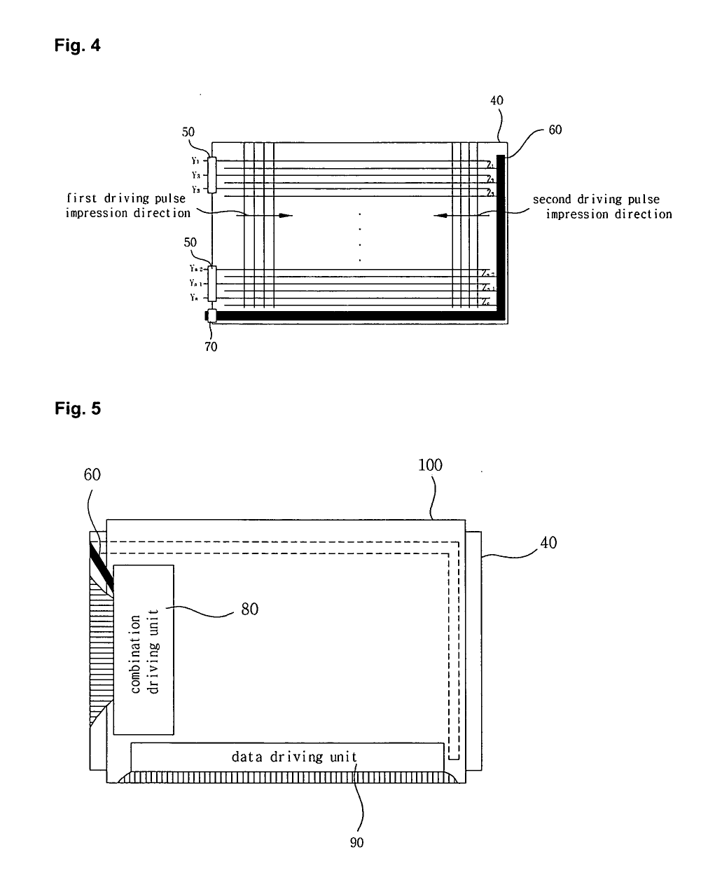

FIG. 4 shows a first embodiment of a plasma display panel according to the present invention. As shown in FIG. 4, the plasma display panel according to the present invention includes a glass substrate 40, a first electrode connection unit 50, a signal transmission unit 60 and a second electrode connection unit 70.

In the glass substrate 40 are formed scan electrodes Y1 to Yn and sustain electrodes Z1 to Zn.

The first electrode connection unit 50 is formed on one side of the glass substrate 40 and transmits a first driving pulse to the scan electrodes Y1 to Yn. The first driving pulse is a pulse for driving the scan electrodes Y1 to Yn. At this time, the first electrode connection unit 50 can be an electrode pad.

The signal transmission unit 60 is formed on the glass substrate 40 and is electrically connected to the sustain electrodes Z1 to Zn that are commonly coupled to the other side of the glass substrate 40. The signal transmission unit 60 is formed on an ineffective surface below the glass substrate 40. Furthermore, the signal transfer line 60 is comprised of the same material as that of the scan electrodes Y1 to Yn and the sustain electrodes Z1 to Zn.

Furthermore, the common coupling of the sustain electrodes Z1 to Zn can be carried out by the signal transmission unit 60. That is, it is shown in FIG. 4 that the signal transmission unit 60 is formed along a right edge of the glass substrate 40 and the ineffective surface of the right edge. However, when considering that the ends of the sustain electrodes Z1 to Zn are electrically connected, the signal transmission unit 60 can be formed only on the ineffective surface at a lower edge of the glass substrate 40.

As described above, the reason why the signal transmission unit 60 is formed on the ineffective surface of the glass substrate 40 and is formed using the same material as that of the scan electrodes Y1 to Yn and the sustain electrodes Z1 to Zn is for forming the signal transmission unit 60 while the scan electrodes Y1 to Yn and the sustain electrodes Z1 to Zn are formed.

If the second electrode connection unit 70 is formed on one side of the glass substrate 40, it transmits a second driving pulse to the signal transmission unit 60. The second driving pulse is a pulse for driving the scan electrodes Z1 to Zn. At this time, the second electrode connection unit 70 can be an electrode pad.

As described above, in the plasma display panel according to a first embodiment of the present invention, the first electrode connection unit 50 and the second electrode connection unit 70 are formed on one side of the glass substrate 40. Furthermore, the signal transmission unit 60 is formed in the glass substrate 40 together with the scan electrodes Y1 to Yn and the sustain electrodes Z1 to Zn and connects the ends of the sustain electrodes Z1 to Zn formed on the other side of the glass substrate 40.

Accordingly, although the first electrode connection unit 50 and the second electrode connection unit 70 are formed on one side of the glass substrate 40 in the same manner, a direction where the first driving pulse is applied to the scan electrodes Y1 to Yn and a direction where the second driving pulse is applied to the sustain electrodes Z1 to Zn are opposite to each other.

As described above, not only one driving unit can generate the first driving pulse and the second driving pulse, but also a direction where the first driving pulse is applied to the scan electrodes Y1 to Yn and a direction where the second driving pulse is applied to the sustain electrodes Z1 to Zn are opposite to each other. Accordingly, the uniformity of images can be improved.

That is, if the first driving pulse and the second driving pulse are applied in the same direction, degradation of images becomes profound from the left toward the right of the plasma display panel due to resistance of the scan electrodes Y1 to Yn and the sustain electrodes Z1 to Zn. Thus, there is a possibility that the uniformity of images may be unbalanced.

To the contrary, if the first driving pulse and the second driving pulse are applied in opposite directions, resistance of the scan electrodes Y1 to Yn increases from the left toward the right of the plasma display panel and resistance of the sustain electrodes Z1 to Zn increases from the right toward the left of the plasma display panel. Thus, the uniformity of images can be maintained.

FIG. 5 shows a first embodiment of a plasma display apparatus including the plasma display panel of FIG. 4 according to the present invention. As shown in FIG. 5, the plasma display apparatus of the present invention includes an integrated driving unit 80, a glass substrate 40, a first electrode connection unit 50, a signal transmission unit 60 and a second electrode connection unit 70.

The same reference numerals as those in FIG. 4 will be used to identify the same component parts.

The integrated driving unit 80 is implemented on a board and generates a first driving pulse and a second driving pulse. This integrated driving unit 80 is attached on a heat radiation plate 100 coupled to a rear surface of the glass substrate, which is corresponds to a lower substrate.

In the glass substrate 40 are formed scan electrodes Y1 to Yn and sustain electrodes Z1 to Zn. At this time, the glass substrate 40 corresponds to an upper substrate of the plasma display panel.

The first electrode connection unit 50 is formed on one side of the glass substrate 40 and transmits a first driving pulse generated by the integrated driving unit 80 to the scan electrodes.

The signal transmission unit 60 is formed in the glass substrate 40 and is electrically connected to the sustain electrodes that are commonly coupled to the other side of the glass substrate 40. The reason why the position of the signal transmission unit 60 shown in FIG. 5 is changed is that the glass substrate 40 shown in FIG. 4 is turned over and then closely adhered to the glass substrate corresponding to the upper substrate.

The second electrode connection unit 60 is formed on one side of the glass substrate 40 and transmits a second driving pulse generated by the integrated driving unit 80 to the signal transmission unit 60.

As described above, since the first electrode connection unit 50 and the second electrode connection unit 60 are formed on one side of the glass substrate 40, the scan electrodes Y1 to Yn and the sustain electrodes Z1 to Zn can be driven by one driving unit. Accordingly, the first embodiment of the present invention can reduce the manufacturing cost and the area occupied by driving units.

### Second Embodiment

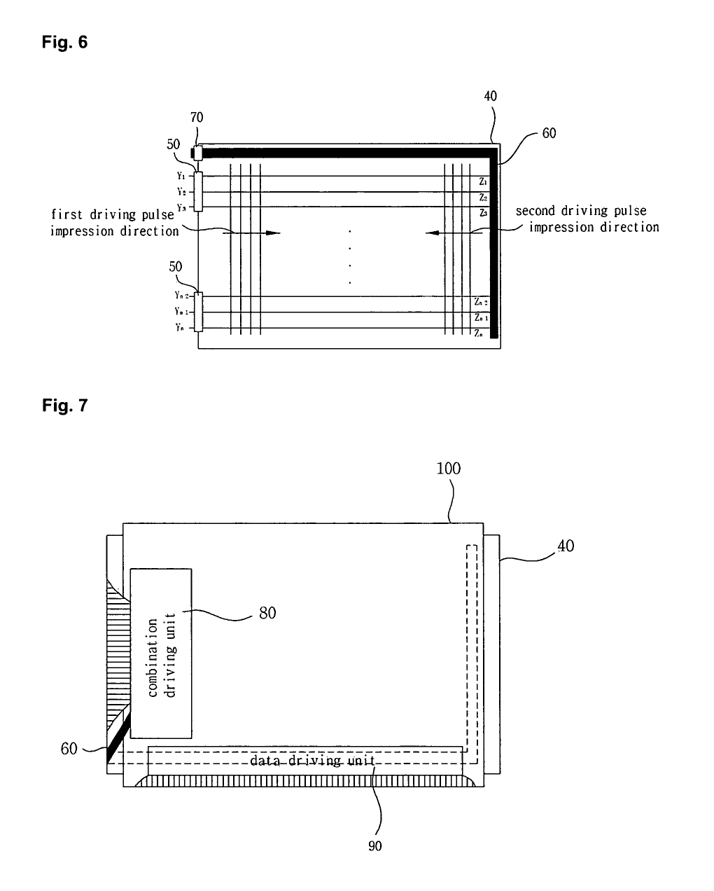

FIG. 6 shows a second embodiment of a plasma display panel according to the present invention. As shown in FIG. 6, the plasma display panel according to the second embodiment of the present invention includes a glass substrate 40, a first electrode connection unit 50, a signal transmission unit 60 and a second electrode connection unit 70. At this time, the remaining components other than the signal transmission unit 60, of the parts of the plasma display panel according to the second embodiment of the present invention are the same as that of the first embodiment. Detailed description thereof will be omitted.

What the second embodiment of the present invention is different from the first embodiment is a position where the signal transmission unit 60 is formed. That is, the signal transmission unit 60 of the first embodiment is formed on the ineffective surface below the glass substrate 40, whereas the signal transmission unit 60 of the second embodiment is formed on the ineffective surface on the glass substrate 40. Furthermore, the signal transfer line 60 is comprised of the same material as that of the scan electrodes Y1 to Yn and the sustain electrodes Z1 to Zn.

In addition, the common coupling of the sustain electrodes Z1 to Zn can be accomplished by the signal transmission unit 60. That is, it is shown in FIG. 6 that the signal transmission unit 60 is formed along an upper edge and a right edge of the glass substrate 40 and the ineffective surface. However, when considering that the ends of the sustain electrodes Z1 to Zn are electrically connected, the signal transmission unit 60 can be formed only on the ineffective surface of the upper edge of the glass substrate 40.

As described above, in the second embodiment of the present invention, the first electrode connection unit 50 and the second electrode connection unit 70 are formed on one side of the glass substrate 40 in the same manner. However, a direction where the first driving pulse is applied to the scan electrodes Y1 to Yn and a direction where the second driving pulse is applied to the sustain electrodes Z1 to Zn are opposite to each other. As described above, not only one driving unit can generate the first driving pulse and the second driving pulse, but also a direction where the first driving pulse is applied to the scan electrodes Y1 to Yn and a direction where the second driving pulse is applied to the sustain electrodes Z1 to Zn are opposite to each other. Accordingly, the uniformity of images can be improved.

FIG. 7 shows a second embodiment of a plasma display apparatus including the plasma display panel of FIG. 6. As shown in FIG. 7, the plasma display apparatus of the present invention includes an integrated driving unit 80, a glass substrate 40, a first electrode connection unit 50, a signal transmission unit 60 and a second electrode connection unit 70. At this time, the remaining components other than the signal transmission unit 60, of the parts of the plasma display panel according to the second embodiment of the present invention are the same as that of the first embodiment. Detailed description thereof will be omitted.

In the plasma display panel according to the second embodiment of the present invention, since the signal transmission unit 60 is formed on an ineffective surface on an upper side of the glass substrate 40. Thus, if the glass substrate 40 shown in FIG. 6 is turned over and then closely adhered to the glass substrate corresponding to the upper substrate, this results in the signal transmission unit 60 as shown in FIG. 7.

As described above, since the first electrode connection unit 50 and the second electrode connection unit 60 are formed on one side of the glass substrate 40, one driving unit can drive the scan electrodes Y1 to Yn and the sustain electrodes Z1 to Zn. Accordingly, the second embodiment of the present invention can reduce the manufacturing cost and the area occupied by driving units.

### Third Embodiment

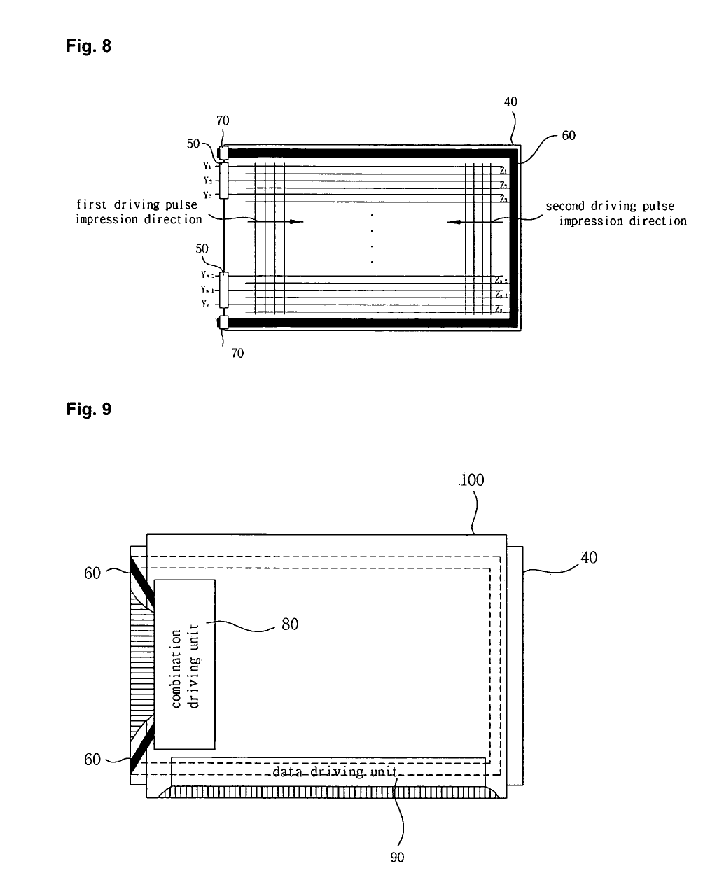

FIG. 8 shows a third embodiment of a plasma display panel according to the present invention.

As shown in FIG. 8, the plasma display panel according to the third embodiment of the present invention includes a glass substrate 40, a first electrode connection unit 50, a signal transmission unit 60 and a second electrode connection unit 70. At this time, the remaining components other than the signal transmission unit 60, of the parts of the plasma display panel according to the third embodiment of the present invention are the same as that of the first embodiment. Detailed description thereof will be omitted.

What the third embodiment of the present invention is different from the first and second embodiments is a position where the signal transmission unit 60 is formed. That is, the signal transmission unit 60 of the first embodiment is formed the ineffective surface on the glass substrate 40 and the signal transmission unit 60 of the second embodiment is formed on the ineffective surface on the glass substrate 40. In contrast, the signal transmission unit 60 of the third embodiment is formed on the ineffective surface on and below the glass substrate 40. Furthermore, the signal transfer line 60 is comprised of the same material as that of the scan electrodes Y1 to Yn and the sustain electrodes Z1 to Zn.

In addition, the common coupling of the sustain electrodes Z1 to Zn can be accomplished by the signal transmission unit 60. That is, it is shown in FIG. 8 that the signal transmission unit 60 is formed along an upper edge, a lower edge and a right edge of the glass substrate 40 and the ineffective surface. However, when considering that the ends of the sustain electrodes Z1 to Zn are electrically connected, the signal transmission unit 60 can be formed only on the ineffective surfaces of the upper edge and the lower edge of the glass substrate 40.

As described above, in the third embodiment of the present invention, the first electrode connection unit 50 and the second electrode connection unit 70 are formed on one side of the glass substrate 40 in the same manner. However, a direction where the first driving pulse is applied to the scan electrodes Y1 to Yn and a direction where the second driving pulse is applied to the sustain electrodes Z1 to Zn are opposite to each other. As described above, not only one driving unit can generate the first driving pulse and the second driving pulse, but also a direction where the first driving pulse is applied to the scan electrodes Y1 to Yn and a direction where the second driving pulse is applied to the sustain electrodes Z1 to Zn are opposite to each other. Accordingly, the uniformity of images can be improved.

FIG. 9 shows a third embodiment of a plasma display apparatus including the plasma display panel of FIG. 8. As shown in FIG. 9, the plasma display apparatus of the present invention includes an integrated driving unit 80, a glass substrate 40, a first electrode connection unit 50, a signal transmission unit 60 and a second electrode connection unit 70. At this time, the remaining components other than the signal transmission unit 60, of the parts of the plasma display panel according to the third embodiment of the present invention are the same as that of a first embodiment. Detailed description thereof will be omitted.

In the plasma display panel according to the third embodiment of the present invention, since the signal transmission unit 60 is formed on an ineffective surface on an upper side and a lower side of the glass substrate 40. Thus, if the glass substrate 40 shown in FIG. 8 is turned over and then closely adhered to the glass substrate corresponding to the upper substrate, this results in the signal transmission unit 60 as shown in FIG. 9.

As described above, since the first electrode connection unit 50 and the second electrode connection unit 60 are formed on one side of the glass substrate 40, one driving unit can drive the scan electrodes Y1 to Yn and the sustain electrodes Z1 to Zn. Accordingly, the third embodiment of the present invention can reduce the manufacturing cost and the area occupied by driving units.

### Fourth Embodiment

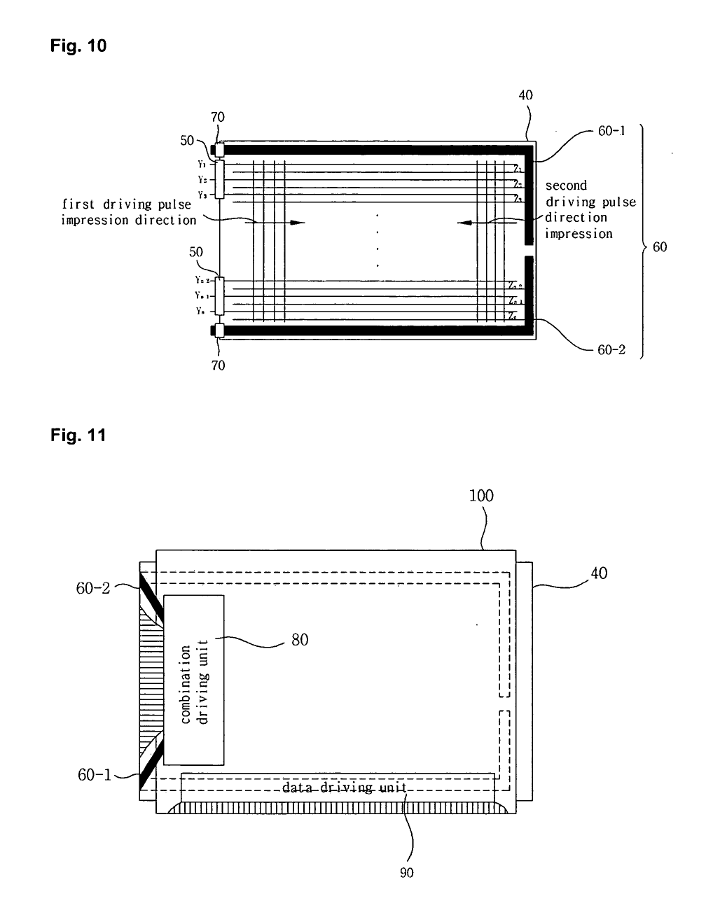

FIG. 10 shows a fourth embodiment of a plasma display panel according to the present invention.

As shown in FIG. 10, the plasma display panel according to the fourth embodiment of the present invention includes a glass substrate 40, a first electrode connection unit 50, a signal transmission unit 60 and a second electrode connection unit 70. At this time, the remaining components other than the signal transmission unit 60, of the parts of the plasma display panel according to the fourth embodiment of the present invention are the same as that of the first embodiment. Detailed description thereof will be omitted.

What the fourth embodiment of the present invention is different from the first, second and third embodiments is the position where the signal transmission unit 60 is formed and the number of the position.

That is, in the fourth embodiment of the present invention, the signal transmission unit 60 consists of a first part signal transmission unit 60-1 and a second part signal transmission unit 60-2. The first part signal transmission unit 60-1 is electrically connected to a part of the sustain electrodes Z1 to Zn formed on the other side of the glass substrate 40. The first part signal transmission unit 60-1 is formed in a region of an ineffective surface on an upper side from an ineffective surface on a right upper side of the glass substrate 40. The second part signal transmission unit 60-2 is formed in a region of an ineffective surface on a lower side from an ineffective surface on a right lower side of the glass substrate 40. Furthermore, the signal transfer line 60 is comprised of the same material as that of the scan electrodes Y1 to Yn and the sustain electrodes Z1 to Zn.

As described above, in the fourth embodiment of the present invention, the first electrode connection unit 50 and the second electrode connection unit 70 are formed on one side of the glass substrate 40 in the same manner. However, a direction where the first driving pulse is applied to the scan electrodes Y1 to Yn and a direction where the second driving pulse is applied to the sustain electrodes Z1 to Zn are opposite to each other. As described above, not only one driving unit can generate the first driving pulse and the second driving pulse, but also a direction where the first driving pulse is applied to the scan electrodes Y1 to Yn and a direction where the second driving pulse is applied to the sustain electrodes Z1 to Zn are opposite to each other. Accordingly, the uniformity of images can be improved.

FIG. 11 shows a fourth embodiment of a plasma display apparatus including the plasma display panel of FIG. 10. As shown in FIG. 11, the plasma display apparatus of the present invention includes an integrated driving unit 80, a glass substrate 40, a first electrode connection unit 50, a signal transmission unit 60 and a second electrode connection unit 70. At this time, the remaining components other than the signal transmission unit 60, of the parts of the plasma display panel according to the fourth embodiment of the present invention are the same as that of the first embodiment. Detailed description thereof will be omitted.

In the plasma display panel according to the fourth embodiment of the present invention, since the signal transmission unit 60 is formed on an ineffective surface on an upper side of the glass substrate 40. Thus, if the glass substrate 40 shown in FIG. 10 is turned over and then closely adhered to the glass substrate corresponding to the upper substrate, this results in the signal transmission unit 60 as shown in FIG. 11.

As described above, since the first electrode connection unit 50 and the second electrode connection unit 60 are formed on one side of the glass substrate 40, one driving unit can drive the scan electrodes Y1 to Yn and the sustain electrodes Z1 to Zn. Accordingly, the fourth embodiment of the present invention can reduce the manufacturing cost and the area occupied by driving units.

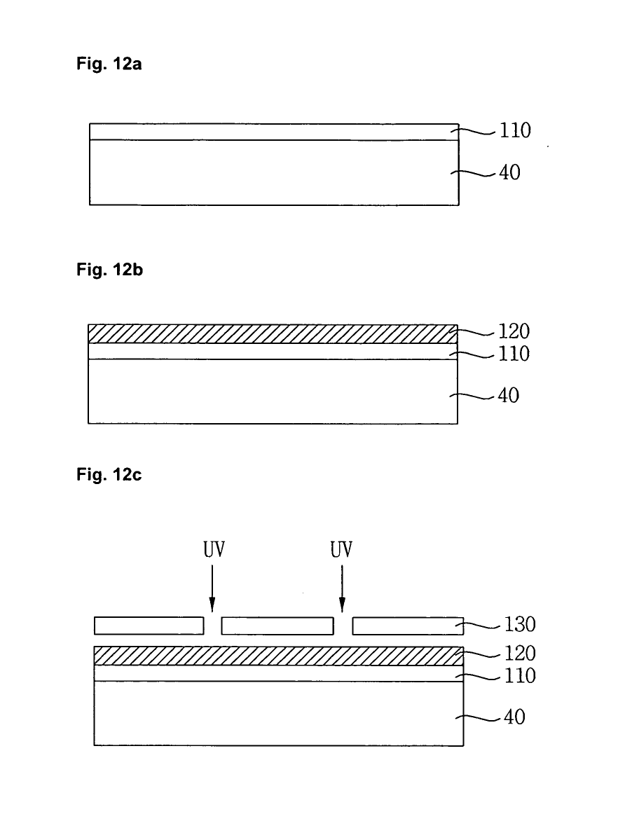

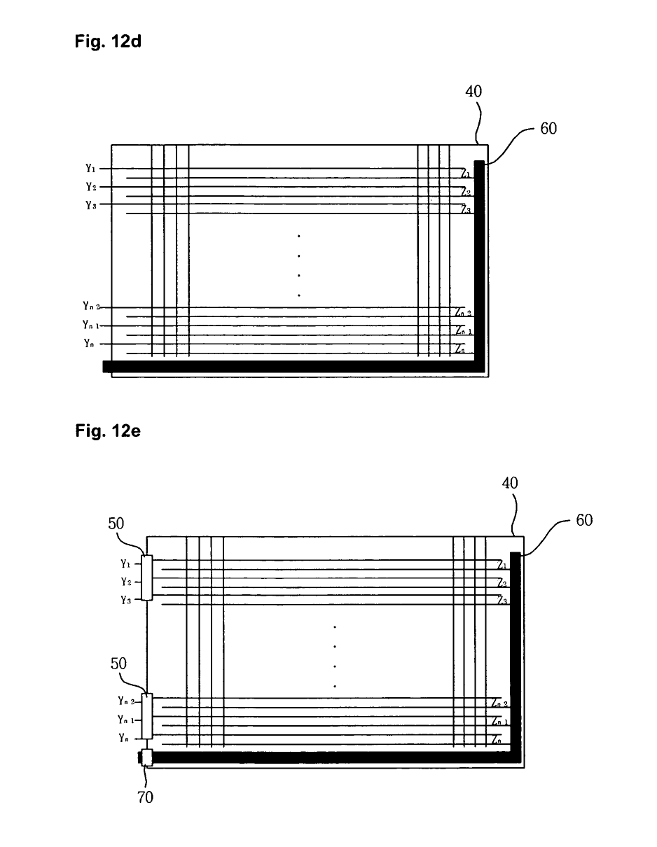

FIGS. 12a to 12e show a process of manufacturing a plasma display panel according to the present invention.

As shown in FIG. 12a, on a glass substrate 40 is accumulated an electrode material layer 110. The electrode material layer 110 is for forming scan electrodes, sustain electrodes and a signal transmission unit through one process at the same time, and it can be formed using silver (Ag), copper (Cu) or the like. Accordingly, the scan electrodes, the sustain electrodes and the signal transmission unit are formed on the same plane of the glass substrate 40.

As shown in FIG. 12b, a photoresist 120 for performing an exposure process is performed on the electrode material layer 110.

As shown in FIG. 12c, the photoresist 120 is irradiated with UV rays using photo masks 130 in which patterns of the scan electrodes, the sustain electrodes and the signal transmission unit are formed. Accordingly, the patterns of the scan electrodes, the sustain electrodes and the signal transmission unit are formed in the photoresist 120. At this time, the pattern of the signal transmission unit is connected to the end of the sustain electrode and is formed on the ineffective surface of the glass substrate 40. The pattern of the signal transmission unit includes the signal transmission unit, which has been described in connection with the first embodiment to the fourth embodiment.

As shown in FIG. 12d, if portions other than the patterns of the scan electrodes, the sustain electrodes and the signal transmission unit are etched using an etchant, scan electrodes Y1 to Yn, sustain electrodes Z1 to Zn and a signal transmission unit 60 are formed.

As described above, after the scan electrodes Y1 to Yn, the sustain electrodes Z1 to Zn and the signal transmission unit 60 are formed, a first electrode connection unit 50 connected to the scan electrodes Y1 to Yn is formed on one side of the glass substrate 40. A second electrode connection unit 50 connected to the signal transmission unit 60 is formed on one side of the glass substrate 40.

Through this manufacturing process, the signal transmission unit 60 of the present invention can be formed using the same material and process as those of the scan electrodes Y1 to Yn and the sustain electrodes Z1 to Zn. Therefore, additional processes are not required.

Furthermore, although the signal transmission unit 60 can be formed using the photolithography shown in FIG. 12, it can be formed using a screen printing method. That is, if a screen mask in which patterns of scan electrodes, sustain electrodes and a signal transmission unit are formed, the signal transmission unit can be formed using the same material and process as those of the scan electrodes Y1 to Yn and the sustain electrodes Z1 to Zn.

As described above, according to the present invention, the manufacturing cost that is increased due to driving units can be lowered through a signal transmission unit formed on an ineffective surface of a glass substrate so as to be connected to sustain electrodes and an electrode connection unit formed on one side of the glass substrate.

The area occupied by driving units can be reduced through a signal transmission unit formed on an ineffective surface of a glass substrate so as to be connected to sustain electrodes and an electrode connection unit formed on one side of the glass substrate.

The uniformity of images can be enhanced through a signal transmission unit formed on an ineffective surface of a glass substrate so as to be connected to sustain electrodes and an electrode connection unit formed on one side of the glass substrate.

Additional processes or manufacturing time are not needed by forming a signal transmission unit using the same material and process as those of scan electrodes and sustain electrodes.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A plasma display panel, comprising:
a glass substrate in which scan electrodes and sustain electrodes are formed;
a first electrode connection unit formed on one side of the glass substrate, for transmitting a first driving pulse to the scan electrodes;
a signal transmission unit formed in the glass substrate and electrically connected to the sustain electrodes that are commonly connected to the other side of the glass substrate; and
a second electrode connection unit formed on one side of the glass substrate, for transmitting a second driving pulse to the signal transmission unit.

2. The plasma display panel as claimed in claim 1, wherein the first electrode connection unit and the second electrode connection unit are electrode pads.

3. The plasma display panel as claimed in claim 1, wherein the scan electrodes, the sustain electrodes and the signal transmission unit are formed of the same material.

4. The plasma display panel as claimed in claim 1, wherein the signal transmission unit is formed on an ineffective surface of the glass substrate.

5. The plasma display panel as claimed in claim 4, wherein the signal transmission unit is formed on an ineffective surface on the glass substrate.

6. The plasma display panel as claimed in claim 4, wherein the signal transmission unit is formed on an ineffective surface below the glass substrate.

7. The plasma display panel as claimed in claim 4, wherein the signal transmission unit is formed on ineffective surfaces on and below the glass substrate.

8. The plasma display panel as claimed in claim 4, wherein the signal transmission unit comprises a first part signal transmission unit and a second part signal transmission unit,
the first part signal transmission unit is electrically connected to a part of the sustain electrodes formed on the other side of the glass substrate and is formed on an ineffective surface on the glass substrate, and
the second part signal transmission unit is electrically connected to the remaining sustain electrodes formed on the other side of the glass substrate and is formed on an ineffective surface below the glass substrate.

9. The plasma display panel as claimed in claim 1, wherein the signal transmission unit commonly connects the sustain electrodes formed on the other side of the glass substrate.

10. A plasma display apparatus, comprising:
an integrated driving unit for generating a first driving pulse and a second driving pulse;
a glass substrate in which scan electrodes and sustain electrodes are formed;
a first electrode connection unit formed on one side of the glass substrate, for transmitting a first driving pulse to the scan electrodes;
a signal transmission unit formed in the glass substrate and electrically connected to the sustain electrodes that are commonly connected to the other side of the glass substrate; and
a second electrode connection unit formed on one side of the glass substrate, for transmitting a second driving pulse to the signal transmission unit.

11. The plasma display apparatus as claimed in claim 10, wherein the scan electrodes, the sustain electrodes and the signal transmission unit are formed of the same material.

12. The plasma display apparatus as claimed in claim 10, wherein the signal transmission unit is formed on an ineffective surface of the glass substrate.

13. The plasma display apparatus as claimed in claim 12, wherein the signal transmission unit is formed on an ineffective surface on the glass substrate.

14. The plasma display apparatus as claimed in claim 12, wherein the signal transmission unit is formed on an ineffective surface below the glass substrate.

15. The plasma display apparatus as claimed in claim 12, wherein the signal transmission unit is formed on ineffective surfaces on and below the glass substrate.

16. The plasma display apparatus as claimed in claim 12, wherein the signal transmission unit comprises a first part signal transmission unit and a second part signal transmission unit,
the first part signal transmission unit is electrically connected to a part of the sustain electrodes formed on the other side of the glass substrate and is formed on an ineffective surface on the glass substrate, and
the second part signal transmission unit is electrically connected to the remaining sustain electrodes formed on the other side of the glass substrate and is formed on an ineffective surface below the glass substrate.

17. The plasma display apparatus as claimed in claim 10, wherein the signal transmission unit commonly connects the sustain electrodes formed on the other side of the glass substrate.

18. A method of manufacturing a plasma display panel including scan electrodes and sustain electrodes, comprising the steps of:
forming a signal transmission unit on a glass substrate using the same electrode material, the signal transmission unit being connected to the scan electrodes and the sustain electrodes and being located on an ineffective surface of the glass substrate;
forming a first electrode connection unit connected to the scan electrodes on one side of the glass substrate; and
forming a second electrode connection unit connected to the signal transmission unit on one side of the glass substrate.

19. The method as claimed in claim 18, wherein the scan electrodes, the sustain electrodes and the signal transmission unit are formed on the same plane of the glass substrate.

20. The method as claimed in claim 18, wherein the formation of the scan electrodes, the sustain electrodes and the signal transmission unit is performed by a photolithography method or a screen printing method.
